(19) United States
(12) Patent Application Publication
(10) Pub. No.: US 2026/0019917 A1
(43) Pub. Date: Jan. 15, 2026

(54) RELAY COMMUNICATION SIDELINK BASED ON QUALITY OF SERVICE (QOS) REQUIREMENTS

(71) Applicant: Kyocera Corporation, Kyoto (JP)

(72) Inventors: Henry CHANG, San Diego, CA (US); Masato FUJISHIRO, Yokohama (JP)

(21) Appl. No.: 18/995,052

(22) PCT Filed: Aug. 8, 2023
(86) PCT No.: PCT/US2023/029713

§ 371 Date: Jan. 15, 2025

Related U.S. Application Data
(60) Provisional application No. 63/396,334, filed on Aug. 9, 2022.

(51) Int. Cl. H04W 40/22; H04W 40/12; H04W 76/14; H04W 88/04

(52) U.S. Cl. CPC H04W 40/22; H04W 40/12; H04W 76/14; H04W 88/04

(57) ABSTRACT

A receiver in a first user equipment (UE) device receives a message from a relay UE device where the message comprises link quality information regarding a communication link between the relay UE device and a second UE device. A controller in the first UE device executes a relay selection procedure for selecting a U2U relay connection between the first UE device and the second CE device for an application. The relay selection procedure is based, at least partially, on a Quality of Service (QoS) requirement of an application and the link quality information.

### CLAIM OF PRIORITY

The present application claims priority to Provisional Application No. 63/396,334, entitled “U2U RELAYING-DISCOVERY AND RELAY RESELECTION,” docket number TPRO 00377 US, filed Aug. 9, 2022, which is assigned to the assignee hereof and hereby expressly incorporated by reference in its entirety.

### FIELD

This invention generally relates to wireless communications and more particularly to relay communication sidelink based on quality of service (QoS) requirements.

### BACKGROUND

Sidelink functionality allows a user equipment (UE) device to communicate directly with another UE device without utilizing a base station. Sidelink relaying functionality allows a remote user equipment (UE) device that is out-of-coverage (OoC) to connect with the gNB or base station via a relay UE device. Relay functionality allows one UE device to connect to another UE device over a relay communication link going through at least one relay UE. In some situations, the relay communication link may also go through one or more base stations or gNBs.

### SUMMARY

A receiver in a first user equipment (UE) device receives a message from a relay UE device where the message comprises link quality information regarding a communication link between the relay UE device and a second UE device. A controller in the first UE device executes a relay selection procedure for selecting a U2U relay connection between the first UE device and the second UE device for an application. The relay selection procedure is based, at least partially, on a Quality of Service (QoS) requirement of an application and the link quality information.

### BRIEF DESCRIPTION OF THE DRAWINGS

FIG. 1 is a block diagram of an example of a system where relay user equipment (UE) devices transmit, to a first UE device, messages including sidelink quality information of each sidelink to a second UE device.

FIG. 2 is a block diagram of an example of a base station (gNB) suitable for use as the gNB.

FIG. 3 is a block diagram of an example of a UE device suitable for use as each of the UE devices.

FIG. 4A is a block diagram of the system for an example where each relay UE device transmits a Model A discovery message.

FIG. 4B is a block diagram of an example of a neighbor list that can be included in a Model A discovery message transmitted from a relay UE device.

FIG. 4C is a block diagram of an example of a QoS configuration. The QoS configuration, therefore is an example of the QoS configuration discussed above.

FIG. 5 is a block diagram of the system for an example where a relay UE device transmits a notification message indicating the quality of the sidelink to a second UE device has fallen below a threshold.

FIG. 6 is a block diagram of the system for an example where each relay UE device transmits a Model B Discovery Request message.

### DETAILED DESCRIPTION

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D).

In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying, and the relay UE device establishes a communication path between the remote UE and a base station (gNB) or cell. In some situations, for example, the UE device may be out of the service area of the base station, and the relay UE device provides a communication link routed from such an out-of-coverage (OoC) UE device through the relay UE device to the base station. Where the destination device is another UE device (target UE device, peer UE device, destination UE device, etc.), the relaying functionality is typically referred to as UE-to-UE (U2U) relaying.

Thus, sidelink relaying functionality allows a remote UE that is out-of-coverage (OoC) to connect with the gNB or base station via a relay UE device. With UE-to-Network (U2N) relaying, the relay UE needs to be in coverage of a cell and connected to the gNB. The relayed connection from the remote UE device to the base station (gNB) includes (1) a PC5 link (sidelink) between the remote UE device and the relay UE device, and (2) a direct communication link (e.g., Uu link) between the relay UE device and the gNB.

A UE device typically executes a selection procedure to select a relay UE device for providing a U2U relay connection to a peer UE device. As discussed herein, a selection procedure may be a procedure to select a relay UE device to establish a new relay connection to a peer UE device or may be a procedure to select a relay UE device to replace an existing relay connection to a peer UE device. Where the relay UE device is selected to replace a relay UE device the process is sometimes referred to as relay reselection. As used herein, therefore, relay selection means relay selection and relay reselection. As part of the relay selection, the UE device may evaluate the quality of sidelink communication links to candidate relay UE devices. For example, the UE device may evaluate measured a Sidelink Reference Signal Received Power (SL RSRP) and/or a measured sidelink discovery RSRP (SD-RSRP) levels from the candidate relay UE devices and may select the relay UE device with the highest quality sidelink connection to the UE device. In conventional systems, the UE device does not have specific information regarding the quality of the sidelink from each relay UE device to the peer UE device. Typically, a candidate relay UE device is a candidate simply because the relay UE device is able communicate with the peer UE device. In some situations, a minimum threshold can be established for the sidelink quality of the sidelink between the relay UE device and the peer device. Such a technique is limited, however, and may not facilitate efficient relay selection. In conventional systems, for example, a UE device cannot perform relay selection based on a Quality of Service (QoS) requirement of an application running on the UE device since the UE device cannot determine whether the sidelink between a candidate relay UE device and the peer device will support the QoS requirement. The techniques discussed herein, however, allow for determining the QoS that is supported by a U2U relay link. In at least some examples, a relay UE device can apply multiple sidelink thresholds to support different QoS requirements. The multiple sidelink thresholds can be mapped to the different QoS requirements.

The techniques provide for transmission of messages from a relay UE device to a first UE device that include information regarding the quality of the sidelink communication link to a second UE device (peer UE device) allowing the first UE device to perform relay selection based on a required QoS and the sidelink quality information. In some examples, the message is a Model A discovery message transmitted from a relay UE device where the discovery message includes information regarding the quality of the sidelink to each neighboring UE device of the relay UE device. In other examples, the relay UE device notifies the first UE device that the quality of the sidelink from the relay UE device to the second UE device has fallen below a threshold suitable to support the QoS requirements of the application using a U2U relay connection between the first UE device and the second UE device through the relay UE device. The message, therefore, may be a notification message from the relay UE device after a U2U relay connection has been established through the relay UE device. In still other examples, the message is a Model B Discovery Request message that indicates the QoS requirements. In one such example, the second UE device transmits a Model B Discovery Request message including a QoS indicator indicative of the QoS requirements where the request message is received by multiple candidate relay UE devices. If a candidate relay UE device determines that the sidelink between the second UE device and the relay UE device can support the QoS requirements, the candidate relay UE device transmits its own Model B Discovery Request message to the first UE device where the request message includes a QoS indicator of the QoS requirement. The first UE device selects the UE relay device for the U2U relay connection from the candidate relay UE devices at least partially based on the QoS requirement and the measured signal quality values of the sidelink communication links to the candidate relay UE devices.

Although the techniques discussed herein may be applied to various types of systems and communication specifications, the devices of the example operate in accordance with at least one revision of the 3rd Generation Partnership Project (3GPP) New Radio (NR) V2X communication specification. The techniques discussed herein, therefore, may be adopted by one or more future revisions of communication specifications, although the techniques may be applied to other communication specifications where sidelink or D2D and relay functionality are employed. More specifically, the techniques may be applied to current and future releases of 3GPP NR specifications. For example, the techniques may also be applied to 3GPP NR (3GPP Rel-17) and 3GPP Rel-18.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

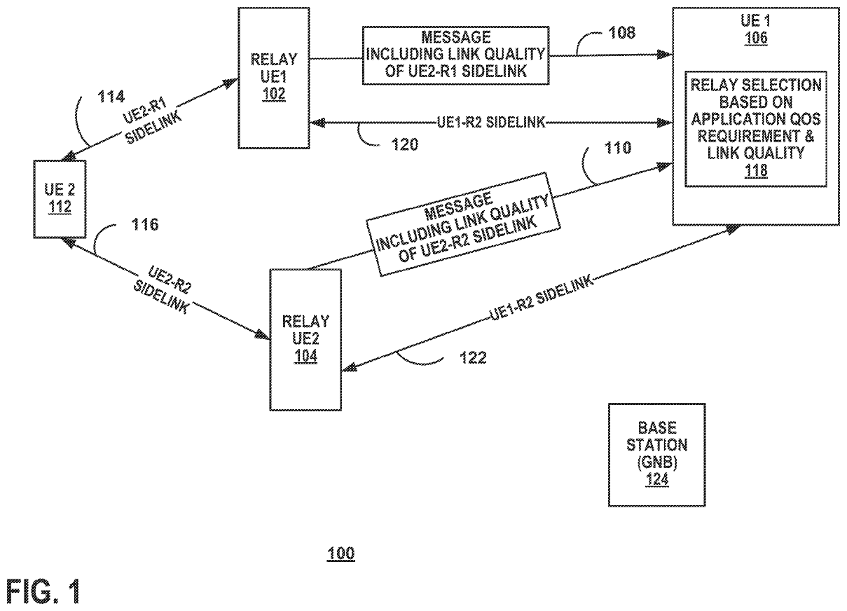

FIG. 1 is a block diagram of an example of a system 100 where relay user equipment (UE) devices 102, 104 transmit, to a first UE device 106, messages 108, 110 including sidelink quality information of each sidelink 114, 116 to a second UE device 112. The first relay UE device 102 transmits the message 108 including the link quality of the UE2-R1 sidelink between the first relay UE device 102 and the second UE device 112. The second relay UE device 104 transmits the message 110 including the link quality of the UE2-R2 sidelink between the second relay UE device 104 and the second UE device 112. The messages 108, 110 may have any of several configurations and may provide the link quality information in numerous ways. Examples of the messages 108, 110 include notification messages, Model B discovery messages and Model A discovery messages. The link quality in the message 108, 110 may be indicated by a measured signal quality value, an indication that a measured signal quality value is above a threshold, below a threshold or in between two thresholds, and a Quality of Service (QoS) indicator that indicates a QoS that the sidelink supports. Other indicators, values, and parameters may also be used.

The first UE device 106 performs a relay selection procedure 118 to select a relay UE device for a U2U relay connection between the first UE device 106 and the second UE device where the selection is at least partially based on the link quality information in the messages and a required QoS of an application that is, or will be, using the U2U relay connection. The relay selection procedure 118 may also evaluate the measured signal quality value of each sidelink 120, 122 to the candidate relay UE devices 102, 104 in selecting the relay UE device for the U2U relay connection. Typically, the application is an application running on both UE devices 106, 112 that uses the U2U relay connection. One or both UE devices 106, 112 may have a QoS requirement for the application. Although FIG. 1 shows two relay UE devices 102, 104, the examples and techniques discussed herein can be applied to any number of devices.

The system 100 also includes a base station (gNB) 124 for the example. In most situations, the base station 124 is not directly involved in the communication link establishment or relay selection. The base station 124, however, may facilitate configuration parameters of the UE devices 102, 104, 106, 112, 604 or provide other system operational parameters. In some situations, for example, the base station 124 may allocate and manage communication resources where one or more of the UE devices 102, 104, 106, 112 are in coverage (InC) of the base station 120. In one example, the base station 124 configures the UE devices when in coverage of the base station 124 with signal measurement threshold values and QoS mapping. The number of QoS levels and the associated measured signal quality range for each QoS level may be configured for each UE device when it enters coverage.

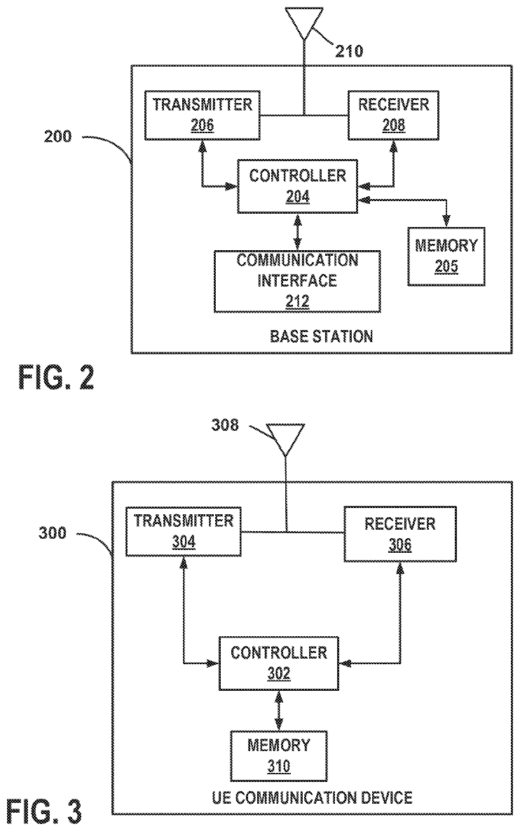

FIG. 2 is a block diagram of an example of a base station (gNB) 200 suitable for use as the base station (gNB) 124. The base station 200 includes a controller 204, transmitter 206, and receiver 208, as well as other electronics, hardware, and code. The base station 200 is any fixed, mobile, or portable equipment that performs the functions described herein. The various functions and operations of the blocks described with reference to the base station 106 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory 205. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. The antenna 210 may also include multiple transmit and receive antennas.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the base station functions. The required components may depend on the particular functionality required by the base station.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

FIG. 3 is a block diagram of an example of a UE device 300 suitable for use as each of the UE devices 102, 104, 106, 112, 604. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory 310. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device. At least the transmitter 304 and receiver 306 form a transceiver in the example. The controller 308 and memory 310 may also be part of the transceiver.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

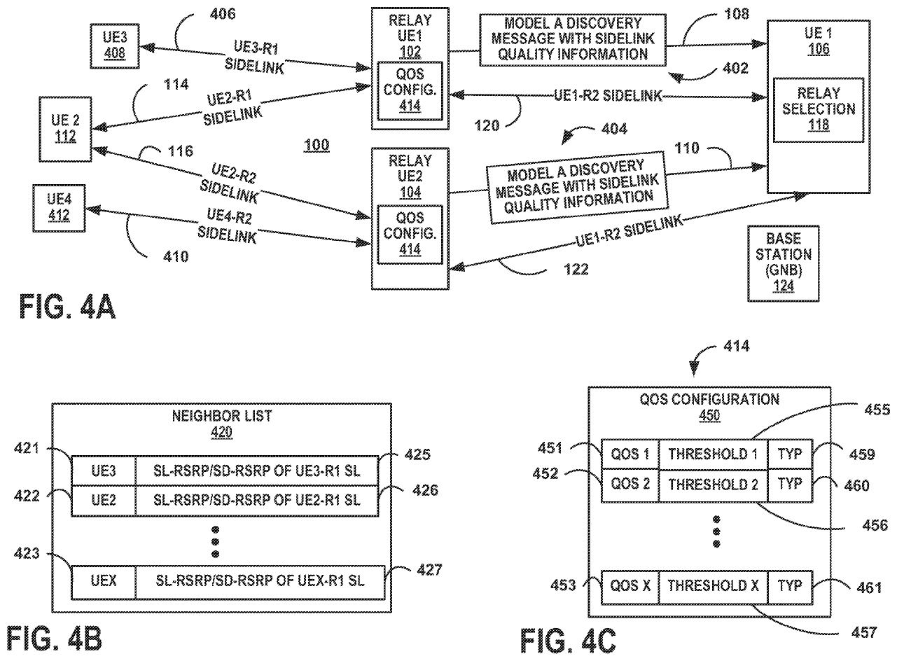

FIG. 4A is a block diagram of the system 100 for an example where each relay UE device 102, 104 transmits a Model A discovery message 402, 404. The discovery message 402, 404 of FIG. 4A. therefore, are examples of the messages 106, 108 discussed with reference to FIG. 1. In accordance with 3GPP communication specifications, Model A discovery messages are announcement messages periodically broadcasted by relay UE devices to announce their presence and the connectivity service they can provide. With conventional techniques, Model A discovery messages do not provide specific sidelink quality information regarding the UE devices that are reachable by the relay UE device. For the example of FIG. 4A, the Model A discovery messages include sidelink quality information for each reachable UE device. As discussed below in further detail, an example of a suitable technique includes transmitting a Model A discovery message including a neighbor list that provides sidelink quality information for each UE device in the neighbor list. As discussed above, the sidelink quality information may include, measured signal quality values, indications related to signal quality thresholds, and QoS indications, as well as other parameters.

Each relay UE device determines the quality of the sidelink to a neighbor UE device by measuring a signal transmitted by the neighbor UE device as received by the relay UE device. Although the link quality may be based on various parameters and/or measurements, an example of a suitable measurement includes a Sidelink Reference Signal Received Power (SL RSRP) measurement of the sidelink. Another suitable example includes sidelink discovery RSRP (SD-RSRP). One or both of the SL RSRP and SD RSRP may be measured. Where the measure signal quality values (SL RSRP, SD RSRP) are compared to a threshold, the threshold may be different. Accordingly, a SL RSRP threshold may be different from the SL SD RSRP threshold when determining a supported QoS requirement for the sidelink.

In the interest of clarity and brevity, each relay UE device 102, 104 measures the sidelink quality for two UE devices. The relay UE devices, however, may be able to detect and measure sidelink quality for any number of UE devices. The first relay UE device 102 determines the sidelink quality for the UE2-R1 sidelink 114 to the second UE device 112 and the sidelink quality for a UE3-R1 sidelink 406 to a third UE device 408. The second relay UE device 104 determines the sidelink quality for the UE2-R3 sidelink 116 to the second UE device 112 and the sidelink quality for a UE4-R2 sidelink 410 to a fourth UE device 412.

For the example, each relay UE device 102, 104 includes a QoS configuration 414 that maps measured signal quality thresholds to QoS levels. An example of a suitable QoS configuration 414 is discussed below with reference to FIG. 4C. The QoS configuration 414 may be preconfigured before UE deployment, preconfigured by a base station (e.g., base station 124) when the relay UE device is in coverage, or may be configured by another UE device. For the example, the UE devices 102, 112, 408, 412 are configured with the same QoS configuration 414.

The first relay UE device 102 generates and transmits the Model A discovery message 402 that includes the sidelink quality information for the second UE device 112 and the third UE device 408. The second relay UE device 104 generates and transmits the Model A discovery message 404 that includes the sidelink quality information for the second UE device 112 and the fourth UE device 412. For the example, each Model A discovery message 402, 404 includes a neighbor list comprising the neighbor UE devices of the relay UE device and a corresponding QoS level supported by the sidelink to the neighbor UE device. The QoS level is determined based on the QoS configuration 114 and the measured signal quality value of the sidelink. The Model A discovery message 402, therefore, identifies the second UE device and the third UE device and indicates the QoS levels that are supported by the UE2-R1 sidelink 114 and the UE3-R1 sidelink 406. The Model A discovery message 404 identifies the second UE device and the fourth UE device 412 and indicates the QoS levels that are supported by the UE2-R2 sidelink 116 and the UE4-R2 sidelink 410. Although in the example the sidelink quality indicator is a supported QoS level, the sidelink quality indicator may be any parameter, indicator, measured value, or combination of values. The sidelink quality indicator included for each neighbor UE device, therefore, may be an SL RSRP value, an SD RSRP value, or a QoS indicator indicating the highest QoS level supported by the sidelink.

After receiving the Model A discovery messages 402, 404, the first UE device 106 evaluates the received sidelink quality information for the second UE device 112 in accordance with the relay selection process 118. For the example, the first UE device 102 also measures the signal quality of the sidelinks 120, 122 for relay selection. Based, at least partially, on the QoS requirement of the application that will use the U2U relay connection to the second UE device 112 and the QoS levels supported by each relay UE device 102, 104, the first UE device 106 selects a relay UE device for the U2U relay connection. Accordingly, the sidelink quality information in the discovery messages 402, 404 allows the first UE device 106 to determine the QoS level supported by the two relay UE devices and to select one of the relay UE devices 102, 104.

FIG. 4B is a block diagram of an example of a neighbor list 420 that can be included in a Model A discovery message transmitted from a relay UE device. The neighbor list includes a UE identifier 421-423 for each of the neighbor UE devices of the relay UE device. Each UE identifier (UE ID) 421-423 is associated with a signal quality indicator 425-427 that is indicative of the quality of the sidelink to the associated UE device. For the example, each signal quality indicator 425-427 is a measured SL-RSRP/SD-RSRP level of the sidelink to the associated UE device. Other signal quality indicators may be used in some situations. In addition, the signal quality indicators may include multiple parameters. For example, each signal quality indicator may include the measured SL RSRP value and the measured SD RSRP value of the sidelink to the associated UE device. In some situations, the signal quality indicator 425-427 may be a QoS indicator indicating the maximum QoS level that is supported by the sidelink to the neighbor UE device.

The neighbor list 420 is an example of a neighbor list that is transmitted by the first relay UE device 106 and includes at least information regarding the second UE device 112, the third UE device 408 and may include information regarding additional neighbor UE devices (indicated by UE X in FIG. 4). The neighbor list 420, therefore, includes UE ID 421 identifying the third UE device 408, a UE ID 422 identifying the second UE device 112, and a UE ID 423 identifying an additional neighbor UE device. The UE ID 421 is associated with a signal quality indicator 425 indicative of the quality of the UE3-R1 sidelink 406 to the third UE device 408. The UE ID 422 is associated with a signal quality indicator 426 indicative of the quality of the UE2-R1 sidelink 114 to the second UE device. The UE ID 423 is associated with a signal quality indicator 427 indicative of the quality of the sidelink to the additional neighbor UE device.

The QoS levels provided as the signal quality indicators 425-427 are based on the preconfigured QoS configuration 414 in the example. The first relay UE device 102 measures a SL RSRP and/or a SD RSRP of each sidelink and associates the measured values to the QoS level mapping of the QoS configuration 414. Other techniques for generating the neighbor list 420 can be used in some circumstances.

FIG. 4C is a block diagram of an example of a QoS configuration 450. The QoS configuration 450 is an example of the QoS configuration 414 discussed above. The QoS configuration 450 includes at least a first QoS level 451 and a second QoS level 452 but may include any number of QoS levels. FIG. 4C includes a third QoS level 453 for QoS level X to illustrate that additional QoS levels may be defined by the QoS configuration 450. Each QoS level 421-423 is associated with one of the plurality of thresholds 455-457. The thresholds 455-457 are indicative of the quality of a sidelink and, for the example, include measured RSRP values. For example, the thresholds 455-457 may be a SD RSRP threshold and/or a SL RSRP threshold that indicate the minimum measured signal quality value of sidelink to be considered adequate to support the associated QoS level. For the example, a threshold type indicator (TYP) 459-461 is included for each threshold 455-457 to indicate whether the associated threshold is a SD RSRP threshold or a SL RSRP threshold. Other techniques may be used to convey such information. In another example, each QoS level is associated with multiple threshold value fields where one or more fields may include values. For example, each QoS level may be associated with an SD RSRP field and an SL RSRP field where either one or both of the fields includes a value.

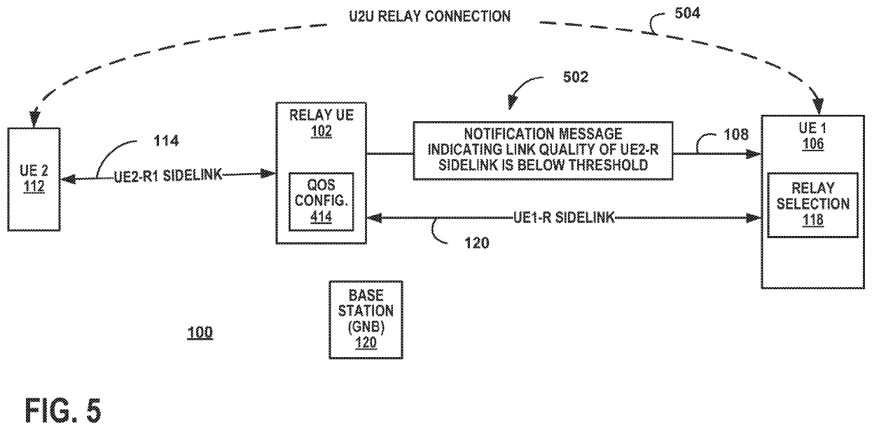

FIG. 5 is a block diagram of the system 100 for an example where a relay UE device 102 transmits a notification message 502 indicating the quality of the sidelink to a second UE device 112 has fallen below a threshold. The discovery message 502 of FIG. 5, therefore, is an example of the message 108 discussed with reference to FIG. 1. For the example, the first UE device 106 is communicating with the second UE device 112 over a U2U relay connection 504 facilitated by the first relay UE device 102. When the signal quality of the UE2-R1 sidelink falls below a threshold, the first relay UE device generates and transmits the notification message 502. In some situations, the threshold is configured by the first UE device 106 and may be a RSRP threshold. In other situations, the notification message is in response to a determination by the relay UE device 102 that a previously reported quality of the UE2-R1 sidelink has changed.

In one example, the U2U relay connection 504 is initiated based on a QoS level for the UE2-R1 sidelink reported in a discovery signal received from the relay UE device. Based on the QoS requirement of the application using the U2U relay connection 504, the first UE device had selected the first relay UE device 102. Subsequently, the first relay UE device 102 determines that the UE2-R1 sidelink 114 no longer can support the QoS level reported in the discovery message. In response, the UE device sends the notification message 502 to the first UE device 106 indicating the new lower QoS level supported by the UE2-R1 sidelink 114 or indicating that the QoS level previously reported is no longer supported.

In another example, the first UE device 106 informs the first relay UE device 102 of the minimum QoS that must be supported by the U2U relay connection 504. The first relay UE device 106 transmits the notification message 502 when the UE2-R1 sidelink 114 no longer supports the QoS provided by the first UE device 106.

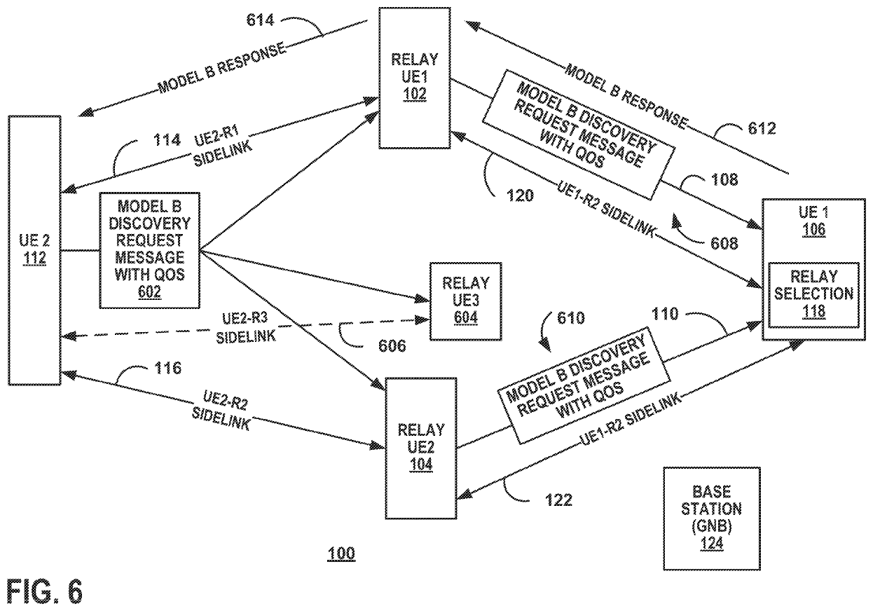

FIG. 6 is a block diagram of the system 100 for an example where each relay UE device 102, 104 transmits a Model B Discovery Request message 608, 610. The discovery messages 608, 610 of FIG. 6, therefore, are examples of the messages 108, 110 discussed with reference to FIG. 1. In accordance with 3GPP communication specifications, the Model B discovery procedure is initiated by a remote UE device by broadcasting a solicitation message indicating the target UE device. Relay UE devices that can provide connectivity to the target UE device send a response message to the first UE device. With conventional techniques, Model B Discovery Request messages do not specify the required sidelink quality for the U2U relay connection and do not specify any minimum RSRP threshold for the sidelink the second UE device. In order to determine whether the relay UE device can provide connectivity to the target UE device, the relay UE device broadcasts its own Model B Discovery Request message in order to determine whether the target UE device is reachable. As with the Model B Discovery Request message broadcasted by the remote UE device, the Model B Discovery Request message broadcasted by the relay UE device does not include any thresholds or QoS requirements in conventional systems. The target UE device may receive Model B Discovery Request messages from multiple relay UE devices and selects the relay UE device for the U2U relay connection. The relay selection by the target UE device in conventional systems, however, is typically based on the sidelink from the target to the relay UE device and cannot be based on the sidelink between the remote UE device and the relay UE device. By receiving the Model B request from the relay UE device, the target relay UE device is only aware that the sidelink between the remote UE device and relay UE device is within communication range (i.e., is reachable).

For the example of FIG. 6, however, the Model B Discovery Request messages received by the target UE device provides information regarding the quality of the sidelink between the remote UE device and relay UE device. In one example, the Model B request message indicates the QoS requirements for the U2U relay connection and does not provide the specific sidelink quality of the sidelink to between the relay UE device and the remote UE device. The transmission of the Model B request message indicates that the remote-relay sidelink meets the QoS requirement since the relay UE device only broadcasts its Model B discovery request when it determines that a quality of the remote-relay sidelink meets the QoS requirement. In another example, the Model B request broadcasted by the relay UE device includes information regarding the quality of the sidelink between the remote UE device and the relay UE device in addition to the QoS requirements specified by the remote UE device. The specified sidelink quality information may include a threshold for a measured signal quality value (e.g., SD RSRP, SL RSRP) or QoS level indicators, as well as other parameters.

For the example of FIG. 6, the first UE device 106 is a target UE device and the second UE device 112 is a remote UE device that is initiating a U2U relay connection. The second UE device 112 broadcasts a Model B discovery request (remote discovery request) 602 that includes, or otherwise indicates, a QoS requirement for a U2U relay connection. The remote discovery request 602 is received by candidate relay UE devices 102, 104, 604 where each candidate relay UE device 102, 104, 604 evaluates the request and the sidelink between the relay UE device and the second UE device 112. Accordingly, the first relay UE device 102 receives the remote discovery request 602 and evaluates the UE2-R1 sidelink 114 to determine if the QoS level specified by the remote discovery request 602 is supported by the UE2-R1 sidelink 114. The second relay UE device 104 receives the remote discovery request 602 and evaluates the UE2-R2 sidelink 116 to determine if the QoS level specified by the remote discovery request 602 is supported by the UE2-R2 sidelink 116. The third relay UE device 604 receives the remote discovery request 602 and evaluates the UE2-R3 sidelink 606 to determine if the QoS level specified by the remote discovery request 602 is supported by the UE2-R3 sidelink 606. For the example, the relay UE devices 102, 104, 604 determine whether their respective sidelinks to the second UE device support the QoS level based on measured SD RSRP and/or SL RSRP levels. For the situation of FIG. 6, only the UE2-R1 sidelink 114 and the UE2-R2 sidelink 116 support the specified QoS level. In response to determining the UE2-R1 sidelink 114 supports the QoS level, the first relay UE device 102 generates and broadcasts a Model B Discovery Request message with a QoS indication 608. In response to determining the UE2-R2 sidelink 116 supports the QoS level, the second relay UE device 104 generates and broadcasts a Model B Discovery Request message with a QoS indication 610. The third relay UE device 604 determines that the UE2-R3 sidelink 606 does not support the QoS level and does not transmit its own discovery request for the situation of FIG. 6.

The first UE device 106 receives the Model B Discovery Request message with QoS indication 608 and the Model B Discovery Request message with QoS indication 610. In addition to the information typically included in a Model B request discovery message transmitted from a relay UE device, the two request messages 608, 610 include a QoS indicator indicating the QoS level required for the application that will be used by the second UE device 112 and the first UE device 106 over the U2U relay connection. For the example of FIG. 6, each of the messages 608, 610 also include the sidelink quality indicator of the sidelink from the relay UE device transmitting message and the second UE device 112. Accordingly, the Model B Discovery Request message with QoS indication 608 includes at least the ID of the second UE device 112, the QoS requirement of the application, and a quality of the UE2-R1 sidelink 114. The Model B Discovery Request message with QoS indication 610 includes at least the ID of the second UE device 112, the QoS requirement of the application, and a quality of the UE2-R2 sidelink 116.

The relay selection procedure 118 is performed at the first UE device 106 to select one of the relay UE devices 102, 104 for the U2U relay connection. For the example, the selection is based at least partially on the QoS requirements, the quality of the sidelinks 114, 116, and the quality of the sidelinks 120, 122. Accordingly, the first UE device 106 measures a parameter indicative of the sidelink quality, such as the SL RSRP or SD RSRP, of the UE1-R1 sidelink 120 and the UE1-R2 sidelink 122. If the quality of the sidelink from the first UE device 106 to a candidate relay UE device does not support the QoS requirements, the candidate relay UE device is not selected in some examples. Where each sidelink to each of multiple candidate relay UE devices can support the QoS requirements, the relay selection procedure applies additional criteria to select a relay UE device. Various parameters and calculations may be used to establish the criteria. In some situations, the relay UE device providing the best U2U relay connection is selected where the best U2U relay connection is determined to be the path with a combined signal quality of the two sidelinks (the quality of the sidelink between the candidate relay UE device and the second UE device combined with the quality of the sidelink between the candidate relay UE device and the first UE device).

In other situations, the best U2U relay connection is determined to be the relay path that does not include a sidelink quality that is near a threshold for supporting the QoS requirements. It may be possible, for example, that a relay path includes one sidelink to the relay UE device that is near the threshold but the quality of the other sidelink to the relay UE device is relatively high such that the combined quality of the path is higher than any other path provided by other candidate relay UE devices. The best path may be determined to be a path that has a lower combined quality but does not include a sidelink with a quality near the threshold for the QoS. Such a selection may be preferred in order to avoid a U2U relay connection that cannot support the QoS requirements when the sidelink with the quality near the threshold only slightly degrades.

In some situations, the quality of the sidelinks to the second UE device 112 may not be included in the Model B Discovery Request messages 608, 610 transmitted from the candidate relay UE devices 102, 104. In such situations, the first UE device 106 can assume that the sidelinks 114, 116 meet the QoS requirements since a Model B Discovery Request messages would not have been transmitted by the candidate relay UE device 102, 104 if the sidelink did not support the QoS requirements. In such situations, the relay selection procedure 118 may base the relay selection on the QoS requirements and the sidelinks 120, 122 from the first UE device 106 to each candidate relay UE device 102, 104.

For the example of FIG. 6, the first relay UE device 106 selects the first relay UE device 102 and transmits a Model B response message 612 to the first relay UE device 102. In response to the response message 612, the first relay UE device 102 transmits a Model B response message 614 to the second UE device 112 that is a response to the Model B Discovery Request message 602. In accordance with known techniques, a U2U relay connection between the first UE device 106 and the second UE device 112 is established. For example, after receiving the Model B response message 614, the second UE device initiates the relay connection establishment procedure by transmitting a Direct Communication Request (DCR) to the first relay UE device 102.

In some situations, the Model B Response message 614 includes sidelink quality information regarding the UE1-R2 sidelink 120. Where no candidate relay UE device can support the QoS requirements, for example, the target UE device (first UE device 106) may select the best U2U relay connection even though it does not support the QoS requirements. Such a situation may occur where the importance of having a connection outweighs having a connection that meets the QoS requirements, such as in emergency situations. After being selected as the relay UE device for the U2U relay connection, the relay UE device 102 determines that the sidelink to the target (UE1-R1 sidelink 120) does not support the original QoS requirements provided by the second UE device 112 in the Model B Discovery Request message 602. In response, the first relay UE device 102 notifies the second UE device 112 that the UE1-R1 sidelink 120 does not support the QoS requirements. An example of a suitable technique of notification includes providing a link quality indicator in the Model B Response message 614 where the link quality indicator is indicative of the quality of the sidelink to the target UE device. In some such situations, the remote UE device (second UE device 112) may make a determination whether the U2U relay connection (that supports a QoS lower that the initial QoS requirements) should be established. Accordingly, the second UE device may not initiate a relay establishment procedure and refrains from transmitting a DCR message.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A first user equipment (UE) device comprising:
a receiver configured to receive a message from a relay UE device, the message comprising link quality information regarding a communication link between the relay UE device and a second UE device; and
a controller configured to execute a relay selection procedure, based at least partially on a Quality of Service (QoS) requirement of an application and the link quality information, the relay selection procedure for selecting a U2U relay connection between the first UE device and the second UE device for the application.

2. The first UE device of claim 1, wherein the receiver is configured to receive another message from another relay UE device, the another message comprising other link quality information regarding another communication link between the another relay UE device and the second UE device,
the controller configured to execute the relay selection procedure to select one of the relay UE device and the another relay UE device for establishing the U2U relay connection.

3. The first UE device of claim 1, further comprising:
a transceiver comprising a transmitter and the receiver, the transceiver configured to communicate over the U2U relay connection between the first UE device and second UE device through the relay UE device,
the transmitter configured to send a quality of service (QoS) indicator to the relay UE device, the QoS indicator indicative of a QoS requirement of an application utilizing the U2U relay connection,
the message indicating that a communication quality of the sidelink connection from the relay UE device to the second UE device is below a threshold required for the QoS requirement, the controller configured to execute, in response to the message, the relay selection procedure as a relay reselection procedure to evaluate alternate U2U relay connections to the second UE device.

4. The first UE device of claim 1, wherein:
the message is a first Model B Discovery Request message indicating the QoS requirement;
the receiver is further configured to receive a second first Model B Discovery Request message from another relay UE device; and
the controller is configured to execute the relay selection procedure, based at least partially on a first measured signal quality of the first Model B Discovery Request message and on a second measured signal quality of the second Model B Discovery Request message.

5. The first UE device of claim 1, wherein the message is a Model A Discovery Request message comprising the link quality information.

6. The first UE device of claim 5, wherein the Model A Discovery Request message comprises a neighbor list comprising a plurality of UE identifiers, each UE identifier identifying a neighbor UE device and associated with a link quality indicator that is indicative of a sidelink quality of a sidelink to the neighbor UE device identified by the associated UE identifier.

7. A first user equipment (UE) device comprising:
a transceiver comprising a transmitter and receiver, the transceiver configured to communicate over a U2U relay connection between the first UE device and second UE device through a relay UE device,
the transmitter configured to send a quality of service (QoS) indicator to the relay UE device, the QoS indicator indicative of a QoS requirement of an application utilizing the U2U relay connection,
the receiver configured to receive a message from the relay UE device, the message indicating that a communication quality of the sidelink connection from the relay UE device to the second UE device is below a threshold required for the QoS requirement; and
a controller configured to execute, in response to the message, a relay reselection procedure to evaluate alternate U2U relay connections to the second UE device.

8. The first UE device of claim 7, wherein the QoS indicator is an updated QoS indicator indicating a change to in the QoS requirement and the notification message is transmitted in response to the change.

9. The first UE device of claim 7, wherein the threshold is a Sidelink Reference Signal Received Power (SL RSRP) threshold.

10. The first UE device of claim 7, the receiver further configured to receive a sidelink quality indicator indicating a first communication quality of the sidelink connection from the relay UE device to the second UE device, the notification message indicating that the first sidelink communication quality has changed.

11. The first UE device of claim 10, wherein the notification message indicates a second communication quality of the sidelink connection from the relay UE device to the second UE device.

12. A first user equipment (UE) device comprising:
a receiver configured to receive a first Model Discovery Request message from a first candidate relay UE device and second Model Discovery Request message from a second candidate relay UE device, the first Model Discovery Request message comprising first link quality information regarding a first communication link between the first candidate relay UE device and a second UE device, the second Model Discovery Request message comprising second link quality information regarding a second communication link between the second candidate relay UE device and the second UE device; and
a controller configured to execute a relay selection procedure to select a selected relay UE device from the first candidate relay UE device and the second candidate relay UE device, the relay selection procedure based at least partially on a Quality of Service (QoS) requirement of an application, the first link quality information and the second link information, the relay selection procedure for selecting a U2U relay connection between the first UE device and the second UE device for the application.

13. The first UE device of claim 12, wherein the first Model B Discovery Request message indicates the QoS requirement and the second Model B Discovery Request message indicates the QoS requirement.

14. The first UE device of claim 13, wherein the controller is configured to select the selected relay UE device at least partially based on a third link quality and a fourth link quality, wherein the third link quality is a quality of a third communication link between the first UE device and the first candidate relay UE device, and wherein the fourth link quality is a quality of a fourth communication link between the first UE device and the second candidate relay UE device.

15. The first UE device of claim 14, wherein the controller is configured to select the first candidate relay UE device when the third link quality supports the QoS requirement and to select the second candidate relay UE device when the fourth link quality supports the QoS requirement.

16. The first UE device of claim 14, wherein the controller is configured to select the first candidate relay UE device when a first combined U2U link quality of the third link quality and a first link quality indicated by the first link quality information is greater than a second combined U2U link quality of the fourth link quality and a second link quality indicated by the second link quality information.

17. The first UE device of claim 16, wherein the third link quality supports the QoS requirement and the fourth link quality supports the QoS requirement.
